(19) United States
(12) Patent Application Publication
(10) Pub. No.: US 2014/0311831 A1
(43) Pub. Date: Oct. 23, 2014

(54) DISK SHAPED LUBRICATING FLUID DISPENSER

(71) Applicant: TRANSMISSION CVTCORP INC., Sainte-Julie (CA)

(72) Inventors: Kenneth Huston, Montreal (CA); Remi Tremblay, Sainte-Julie (CA); Alexandre Blouin, Beloeil (CA)

(73) Assignee: TRANSMISSION CVTCORP INC., Sainte-Julie (CA)

(21) Appl. No.: 14/255,477

(22) Filed: Apr. 17, 2014

Related U.S. Application Data
(60) Provisional application No. 61/813,282, filed on Apr. 18, 2013.

(51) Int. Cl. F16H 57/04

(52) U.S. Cl. CPC F16H 57/0434; F16H 57/0489
USPC 184/14

(57) ABSTRACT

A disk shaped lubricating fluid dispenser to dispense lubricating fluid on rotating disks requiring film lubrication is described. The various embodiments provide a relatively constant and uniform 360-degree coverage of lubricating fluid on a rotating disk via a plurality of diffusing pins.

### CROSS-REFERENCE TO RELATED APPLICATIONS

This application claims priority to and the benefit of U.S. provisional patent application number 61/813,282, filed on Apr. 18, 2013, the entire contents of which are hereby incorporated by reference herein.

### FIELD

The present disclosure generally relates to fluid dispensers. More specifically, the present disclosure is concerned with disk shaped lubricating fluid dispenser.

### BACKGROUND

Lubricating fluid is known to be used, for example, on rotating disks requiring film lubrication. However, providing relatively constant and uniform 360 degree coverage of lubricating fluid on a rotating disk may prove difficult.

### BRIEF DESCRIPTION OF THE DRAWINGS

In the appended drawings:

FIG. 1 is a sectional side elevation view of a dual-cavity full toroidal continuously variable transmission (CVT) including a disk shaped lubricating fluid dispenser according to a first illustrative embodiment;

FIG. 2 is an enlarged view of a portion of the CVT of FIG. 1;

FIG. 3 is a perspective view of the disk shaped lubricating fluid dispenser according to the first illustrative embodiment; and

FIG. 4 is a front elevation view of the disk shaped lubricating fluid dispenser of FIG. 3, shown mounted to a hollow shaft and illustrating the flow of lubricating fluid;

FIG. 5 is a front elevation view similar to FIG. 4 illustrating a disk shaped lubricating fluid dispenser according to a second illustrative embodiment;

FIG. 6 is a front elevation view similar to FIG. 4 illustrating a disk shaped lubricating fluid dispenser according to a third illustrative embodiment;

FIG. 7 is a front elevation view similar to FIG. 4 illustrating a disk shaped lubricating fluid dispenser according to a fourth illustrative embodiment;

FIG. 8 is a front elevation view similar to FIG. 4 illustrating a disk shaped lubricating fluid dispenser according to a fifth illustrative embodiment;

FIG. 9 is a front elevation view similar to FIG. 4 illustrating a disk shaped lubricating fluid dispenser according to a sixth illustrative embodiment;

FIG. 10 is a front elevation view similar to FIG. 4 illustrating a disk shaped lubricating fluid dispenser according to a seventh illustrative embodiment;

FIG. 11 is a front elevation view similar to FIG. 4 illustrating a disk shaped lubricating fluid dispenser according to a eighth illustrative embodiment;

FIG. 12 is a front elevation view similar to FIG. 4 illustrating a disk shaped lubricating fluid dispenser according to a ninth illustrative embodiment;

FIG. 13 is a front elevation view similar to FIG. 4 illustrating a disk shaped lubricating fluid dispenser according to a tenth illustrative embodiment;

FIG. 14 is a front elevation view similar to FIG. 4 illustrating a disk shaped lubricating fluid dispenser according to a eleventh illustrative embodiment;

FIG. 15 is a perspective view similar to FIG. 3 illustrating a disk shaped lubricating fluid dispenser according to a twelfth illustrative embodiment;

FIG. 16 is a sectional view similar to FIG. 2 illustrating the mounting of the disk shaped lubricating fluid dispenser of FIG. 15 mounted to the hollow shaft; and

FIG. 17 is a sectional view similar to FIG. 16, illustrating one of the fluid passages.

### DETAILED DESCRIPTION

An object is generally to provide an improved fluid dispenser. More specifically, a disk shaped lubricating fluid dispenser is described herein.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The term “about” is used to indicate that a value includes an inherent variation of error for the device or the method being employed to determine the value.

It is to be noted that while the expression “Toroidal CVT”, standing for Continuously Variable Transmission is used herein to describe a dual-cavity full toroidal CVT, this expression is to be construed herein and in the appended claims as including any type of toroidal CVT such as, for example, half-toroidal CVT and single cavity toroidal CVT.

It is also to be noted that the expression “diffusing wall” is to be construed herein and in the appended claims as being a fixed element positioned in the flow of fluid in view of changing the flow direction and/or splitting the flow.

Generally stated an illustrative embodiment is concerned with a disk shaped lubricating fluid dispenser including a generally circular body provided with a central opening; at least one fluid inlet apertures provided in the vicinity of the central opening. For each at least one fluid inlet apertures, diffusing walls are provided downstream from the at least two fluid inlet apertures whereby, fluid entering the disk shaped lubricating fluid dispenser through the at least one fluid inlet apertures is diffused by the diffusing walls.

Other objects, advantages and features of the disk shaped lubricating fluid dispenser will become more apparent upon reading of the following non-restrictive description of illustrative embodiments thereof, given by way of example only with reference to the accompanying drawings.

Toroidal Continuously Variable Transmissions (hereinafter generically referred to as “CVT”) are believed well known in the art. The operation of such a CVT will therefore only be briefly discussed herein.

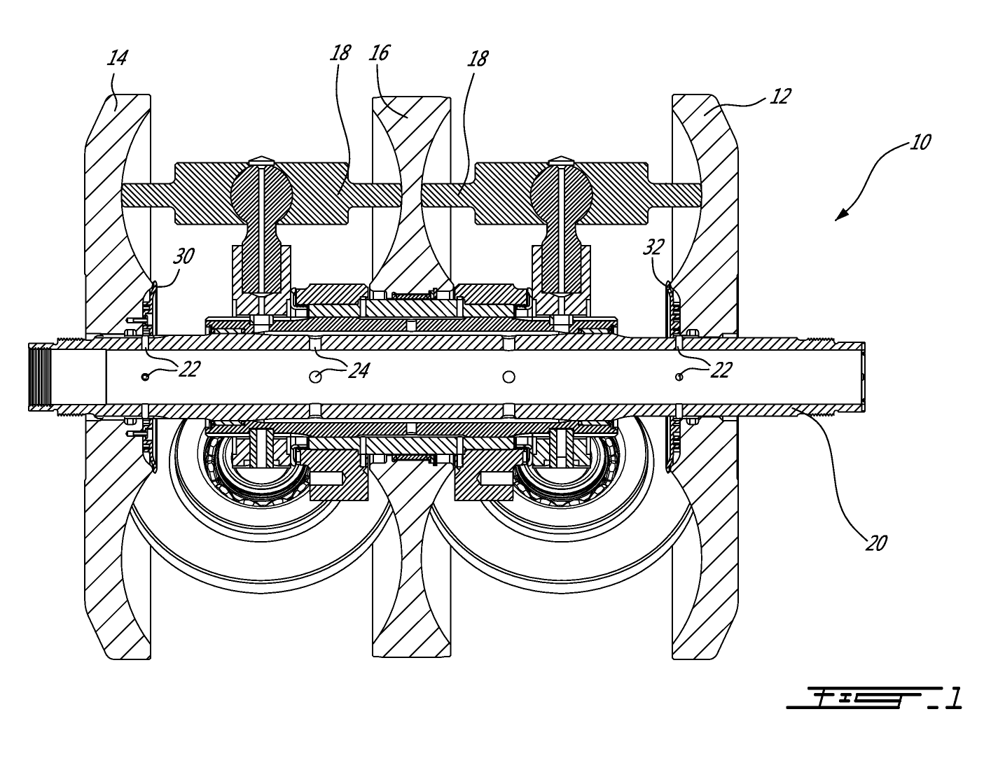

As can be seen from FIG. 1 of the appended drawings, a dual-cavity toroidal CVT 10 is provided with first and second drive disks 12 and 14 having a toroidal surface, a driven disk 16 also having two opposed toroidal surfaces each facing the toroidal surface of one of the drive disks 12 and 14. The disks being linked by rollers 18 in contact with their respective toroidal surfaces. The angle of the rollers with respect to the drive and driven disks dictates the speed ratio between the driven and drive disks. A shaft 20 interconnects the drive disks 12 and 14 and rotationally supports the driven disk 16. The hollow shaft 20 also serves as a lubrication fluid distribution hub and is provided with various size apertures 22 and 24 to supply lubrication fluid to various portions of the CVT 10.

While the CVT 10 is in operation, a thin film of traction/lubrication fluid is present between the contacting surfaces of the rollers and disks. This film of fluid has to be constantly replenished since high-speed rotation of the rollers and disks forces the fluid outwardly.

Accordingly, a fluid dispensing mechanism must be used. The dual-cavity CVT 10 of FIG. 1 is therefore provided with two identical disks shaped lubricating fluid dispenser 30 and 32, according to an illustrative embodiment, to dispense lubricating fluid on the two drive disks 12 and 14.

Since the disk shaped lubricating fluid dispenser 30 and 32 are identical and for concision purpose, only the disk shaped lubricating fluid dispenser 32 will be described hereinbelow.

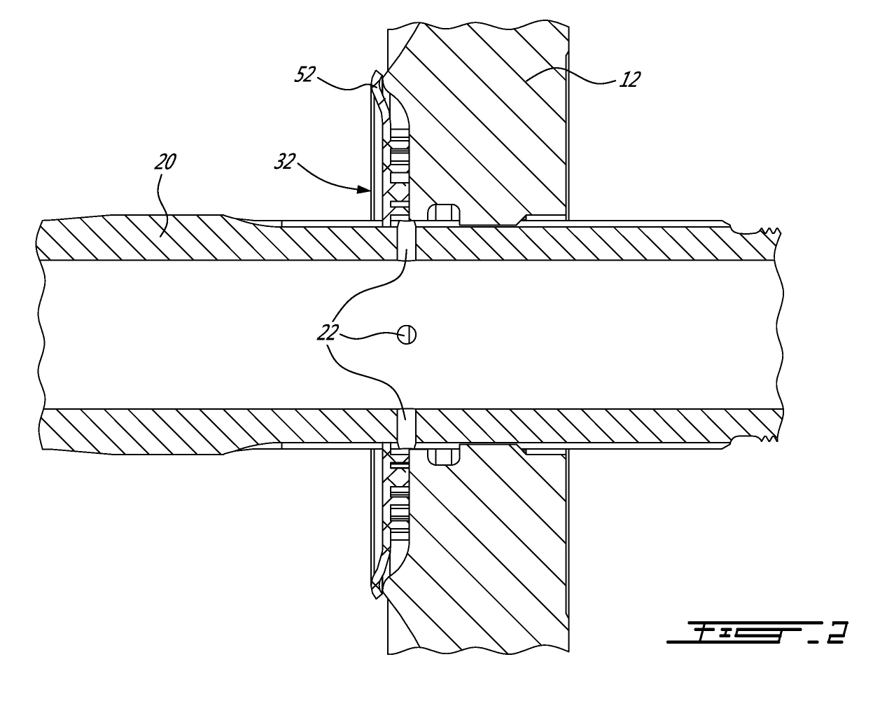

As can be better seen from FIG. 2, the disk shaped lubricating fluid dispenser 32 is so mounted to the shaft 20 against the drive disk 12 as to overlay four lubricating fluid apertures 22 (only 3 shown). Generally stated, the purpose of the disk shaped lubricating fluid dispenser 32 is to spread the lubricating fluid coming from the four apertures 22 into a relatively constant and uniform 360 degrees coverage of lubricating fluid on the rotating drive disk 12.

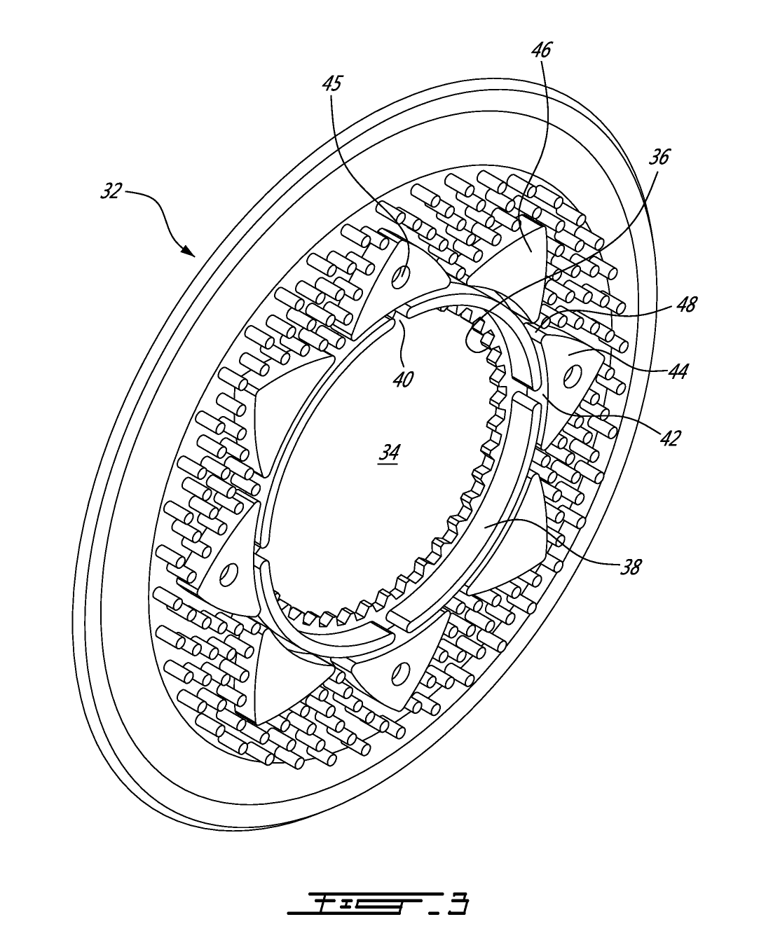

Turning now to FIG. 3, the disk shaped lubricating fluid dispenser 32 will be described.

As can be seen from this figure, the disk shaped lubricating fluid dispenser 32 is a one-piece element. The disk shaped lubricating fluid dispenser 32 includes a body provided with a central opening 34 defined by a splined internal edge 36. The disk shaped lubricating fluid dispenser 32 may therefore be mounted to a splined portion of the shaft 20 so as to rotate therewith.

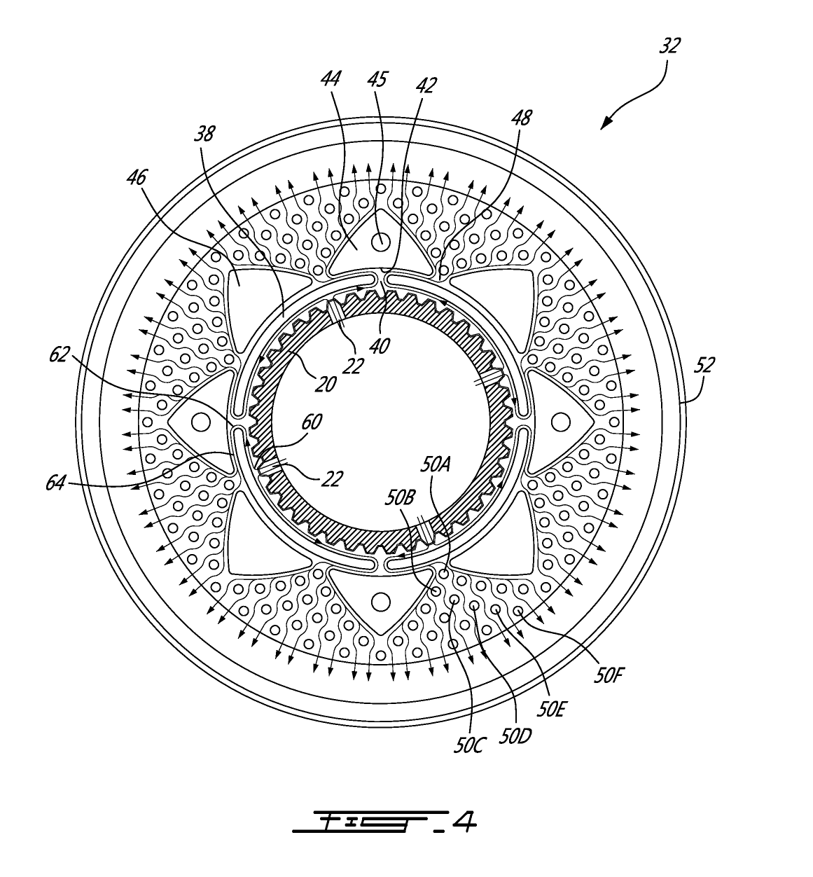

As can be better seen from front elevation view of FIG. 4, the disk shaped lubricating fluid dispenser 32 includes four (4) primary curved walls 38 separated by four (4) primary apertures 40 defined by opposite ends of the walls 38. Each primary aperture 40 faces a secondary wall 42, which is part of a triangular space-limiting element 44. Four more triangular space-limiting elements 46 are provided between the space-limiting elements 44. Accordingly, eight (8) secondary apertures 48 are defined by the space between adjacent space-limiting elements 44, 46.

The space limiting elements 44 are each provided with an aperture 45 allowing the disk shaped lubricating fluid dispenser 32 to be mounted to the first drive disk 12.

Downstream from each secondary aperture 48 are diffusing walls in the form of six levels of diffusing pins 50A-50F positioned as a curved Galton board. The first level including one pin 50A; the second level including two pins 50B; the third level including three pins 50C; the fourth level including four pins 50D; the fifth level including five pins 50E; and the sixth level including six pins 50F. It is to be noted that the outer pins 50F of the sixth level are shared by adjacent curved Galton Boards.

As can be better seen from FIG. 2, the disk shaped lubricating fluid dispenser 32 also includes a peripheral lubrication fluid depositing recurve 52 so configured and sized as to be adjacent the beginning of the toroidal surface of the first drive disk 12.

Returning to FIG. 4 of the appended drawings, the operation of the disk shaped lubricating fluid dispenser 32 will be described.

A theoretical flow of lubricating fluid will now be described. As mentioned hereinabove, the lubrication fluid is conveyed via the hollow shaft 20 and egress via the apertures 22 (see arrows 60). The fluid then hits the curved primary walls 38 and is diverted on either side thereof. The fluid then reaches the primary apertures 40 (see arrow 62) before hitting the secondary walls 42 and is again diverted on either side thereof. The secondary apertures are then reached (see arrows 64) and the diffusing pins 50A of the first level are reached.

The lubricating fluid is then diffused by the six levels of diffusing pins 50A to 50F according to the Galton board effect since the disk shaped lubricating fluid dispenser 32 is rotating. Indeed, centrifugal forces are applied outwardly on the lubricating fluid, forcing it outwardly. When the fluid impacts the pins, it is diffused thereby. Accordingly, the level of lubricating fluid reaching the peripheral lubrication fluid depositing recurve 52 is generally equal on the entire periphery of the disk shaped lubricating fluid dispenser 32, therefore supplying lubricating fluid on the entire toroidal surface of the drive disk 12.

It is to be noted that the spaces between the triangular space-limiting elements 46 and the secondary walls 48 are filled with lubricating fluid (not shown) since a small portion of the lubricating fluid passes each secondary apertures 48 until the space is filled.

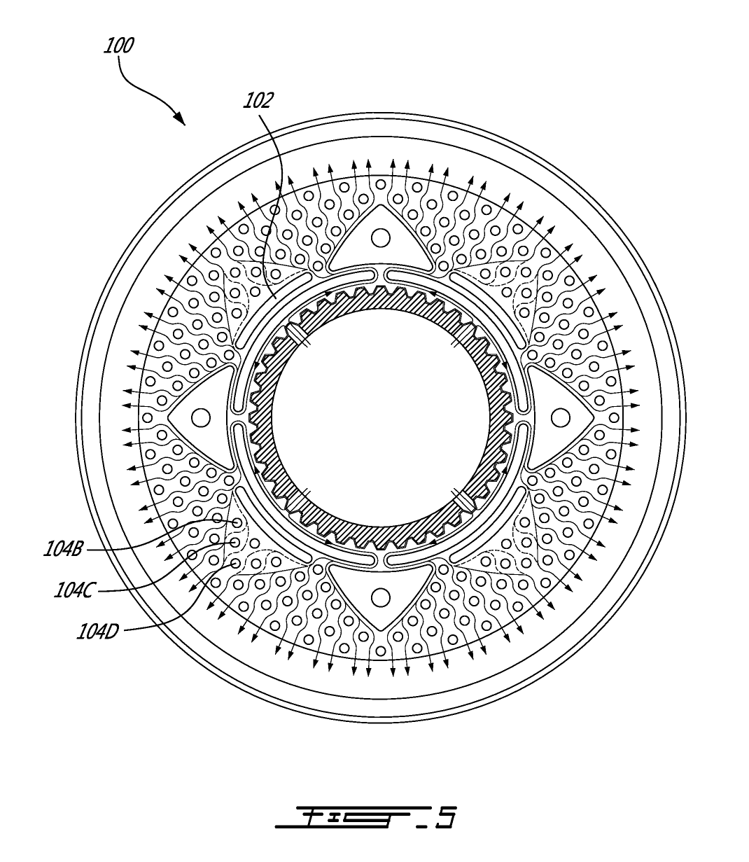

Turning now to FIG. 5 of the appended drawings, a disk shaped lubricating fluid dispenser 100 according to a second illustrative embodiment will be described. The disk shaped lubricating fluid dispenser 100 is very similar to the disk shaped lubricating fluid dispenser 32 described hereinabove and illustrates in FIG. 1-4. Accordingly, for concision purposes, only the differences therebetween will be described.

Generally stated, the main difference between the disk shaped lubricating fluid dispenser 100 and the disk shaped lubricating fluid dispenser 32 is the replacement of each of the four triangular space-limiting elements 46 by a wall 102 and six supplemental diffusing pins 104B-104D on the levels 2 to 4. The wall 102 ensures that the space that is being filled with lubricating before the lubricating fluid is diffused by the pins 102A-102F is not too large and the supplemental diffusing pins 104B-104D ensure that should lubricating fluid be diverted in their direction (shown in dashed lines in FIG. 5), the Galton Board effect will take place and adequately diffuse the lubricating fluid towards the peripheral recurve 52.

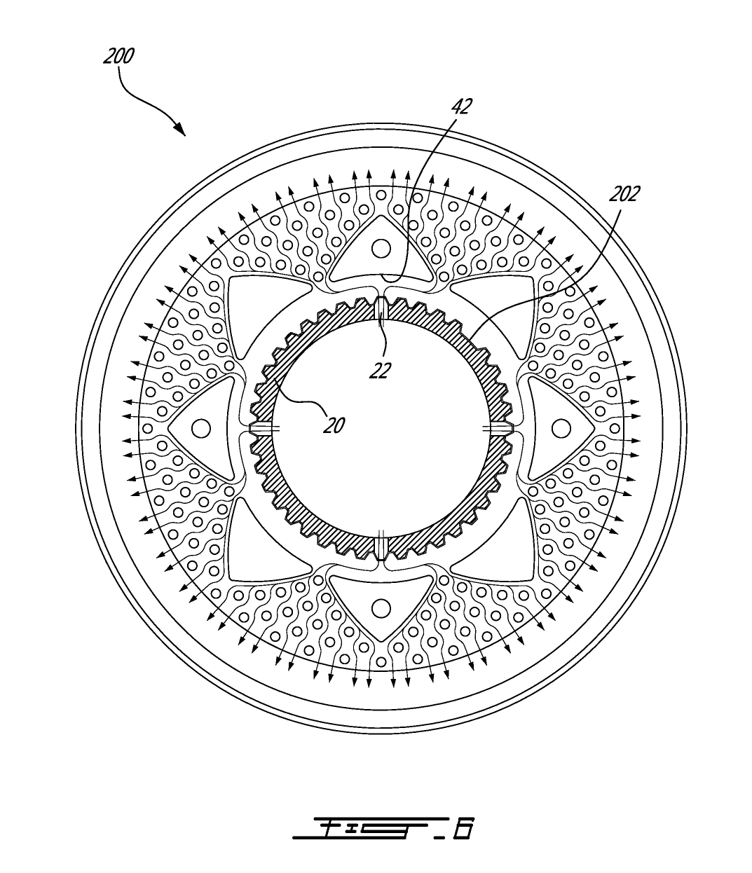

Turning now to FIG. 6 of the appended drawings, a disk shaped lubricating fluid dispenser 200 according to a third illustrative embodiment will be described. The disk shaped lubricating fluid dispenser 200 is very similar to the disk shaped lubricating fluid dispenser 32 described hereinabove and illustrates in FIG. 1-4. Accordingly, for concision purposes, only the differences therebetween will be described.

Generally stated, in the disk shaped lubricating fluid dispenser 200, the primary curved walls 38 have been removed and positioning means, in the form of one larger spline 202, has been added. Accordingly, the apertures 22 of the hollow shaft 20 are always positioned in the middle of a secondary curved wall 42 allowing the removal of the primary curved walls 38.

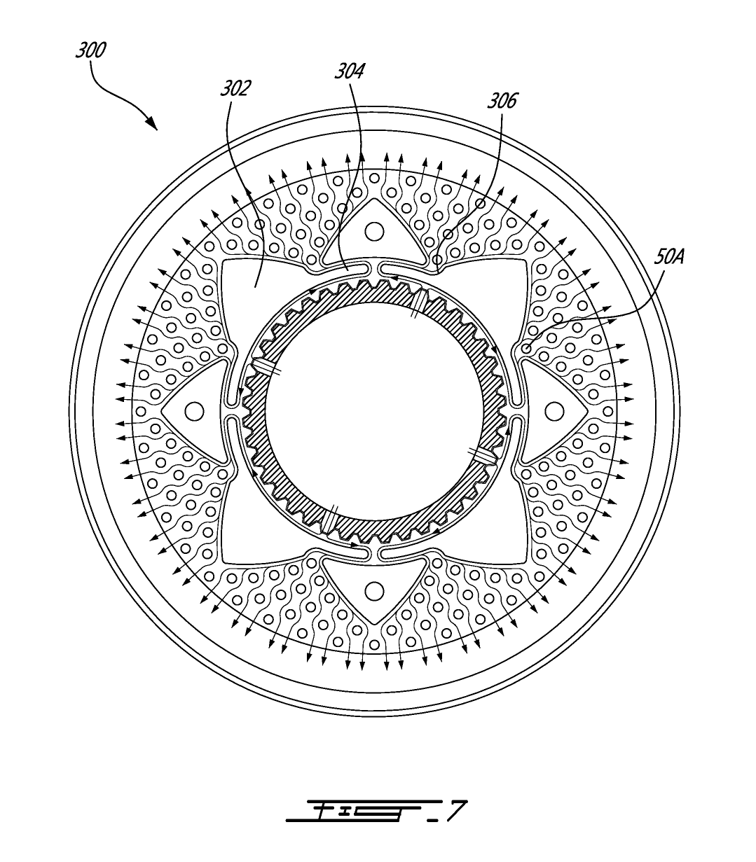

Turning to FIG. 7 of the appended drawings, a disk shaped lubricating fluid dispenser 300 according to a fourth illustrative embodiment will be described. The disk shaped lubricating fluid dispenser 300 is very similar to the disk shaped lubricating fluid dispenser 32 described hereinabove and illustrates in FIG. 1-4. Accordingly, for concision purposes, only the differences therebetween will be described.

Generally stated, in the disk shaped lubricating fluid dispenser 300, the size and shape of the four triangular space-limiting elements 302 have been changed so that the space-limiting elements 302 and the primary curved walls 304 are integral. Accordingly, lubrication fluid does not have to fill the space between the primary curved walls 38 and the space-limiting elements. Furthermore, the curved portion 306 at the junction between the primary curved walls and the space-limiting elements is so curved that lubricating fluid is directed directly onto the diffusing pins 50A of the first level. One skilled in the art will understand that the size, position and spacing of the diffusing pins 50A-50F has to be designed according to the range of rotational speed of the disk shaped lubricating fluid dispenser and the viscosity of the lubricating fluid so that an adequate diffusion of the lubricating fluid is achieved. For example, the radial position of the first level of diffusing pin 50A ensures that the primary diffusion of the lubricating fluid is adequate.

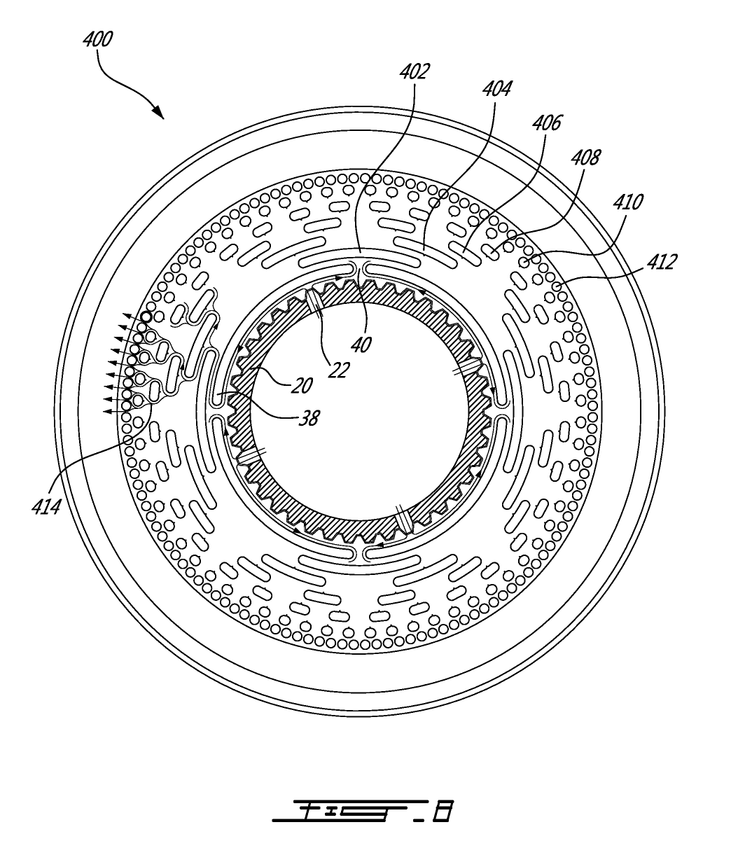

Turning now to FIG. 8 of the appended drawings, a disk shaped lubricating fluid dispenser 400 according to a fifth illustrative embodiment will be described. The disk shaped lubricating fluid dispenser 400 is very similar to the disk shaped lubricating fluid dispenser 32 described hereinabove and illustrates in FIG. 1-4. Accordingly, for concision purposes, only the differences therebetween will be described.

The disk shaped lubricating fluid dispenser 400 includes six (6) levels of secondary walls 402, 404, 406, 408, 410 and 412, that are progressively smaller and centered on the previous level of walls to thereby progressively divide the flow of fluid until it egresses the dispenser 40. Each secondary wall of levels 404, 406, 408 and 410 optionally includes a small pointed center portion where the fluid from the previous level impacts the wall, thereby helping the division of the fluid on either side thereof.

A theoretical flow of fluid in shown by arrows 414.

One skilled in the art will understand that triangular space-limiting elements (not shown) similar to the elements 46 of FIG. 4 could be provided in the free spaces of the dispenser 400.

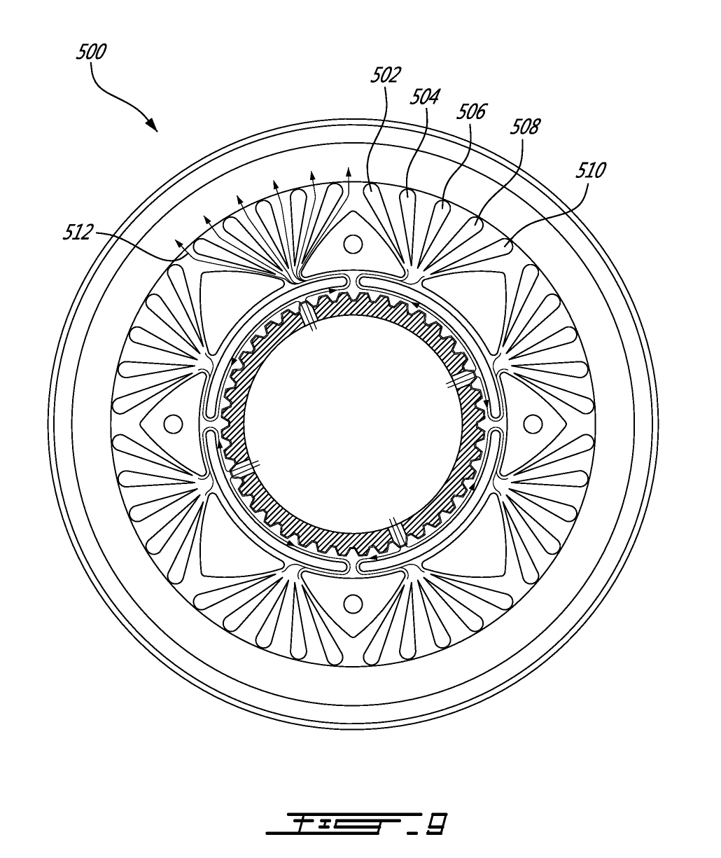

Turning now to FIG. 9 of the appended drawings, a disk shaped lubricating fluid dispenser 500 according to a sixth illustrative embodiment will be described. The disk shaped lubricating fluid dispenser 500 is very similar to the disk shaped lubricating fluid dispenser 32 described hereinabove and illustrates in FIG. 1-4. Accordingly, for concision purposes, only the differences therebetween will be described.

The fluid dispenser 500 includes, instead of levels of pins, fanning diffusing walls 502, 504, 506, 508 and 510 defining diffusing channels therebetween that split and diffuse the lubricating fluid as shown by the arrows 512 illustrating a theoretical flow of lubricating fluid.

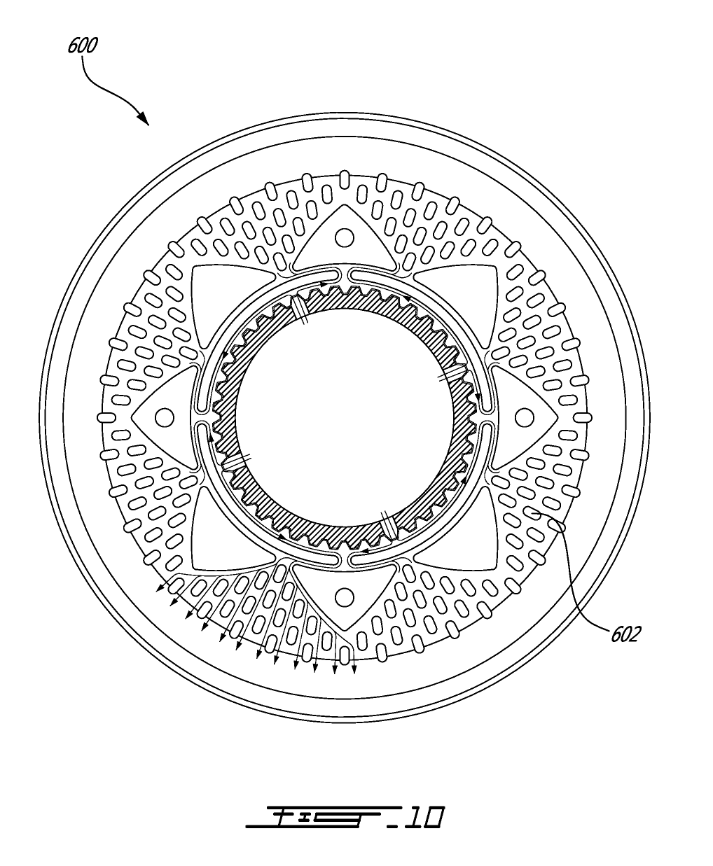

Turning now to FIG. 10 of the appended drawings, a disk shaped lubricating fluid dispenser 600 according to a seventh illustrative embodiment will be described. The disk shaped lubricating fluid dispenser 600 is very similar to the disk shaped lubricating fluid dispenser 32 described hereinabove and illustrates in FIG. 1-4. Accordingly, for concision purposes, only the differences therebetween will be described.

The fluid dispenser 600 includes oblong pins 602 positioned in levels as described with respect to FIG. 4.

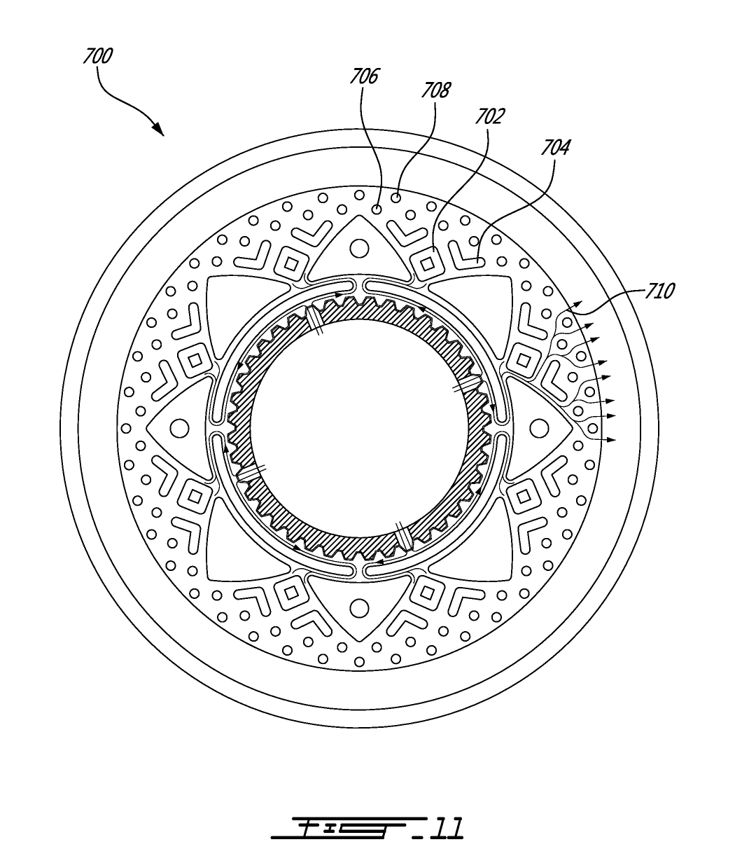

Turning now to FIG. 11 of the appended drawings, a disk shaped lubricating fluid dispenser 700 according to a eighth illustrative embodiment will be described. The disk shaped lubricating fluid dispenser 700 is very similar to the disk shaped lubricating fluid dispenser 32 described hereinabove and illustrates in FIG. 1-4. Accordingly, for concision purposes, only the differences therebetween will be described.

The disk shaped lubricating fluid dispenser 700 includes different shape of diffusing walls. A first level of diffusing walls includes a square wall 702, while the second level includes two arrow shaped walls 704. Third and a fourth levels of diffusing walls include staggered diffusing pins 706 and 708. A theoretical flow of fluid is illustrated by arrows 710.

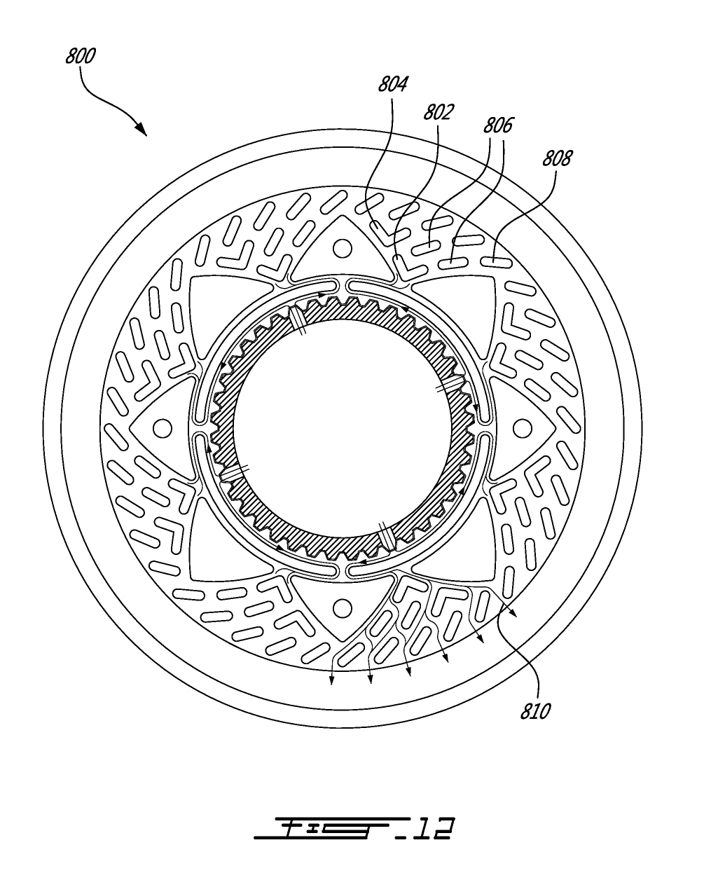

Turning now to FIG. 12 of the appended drawings, a disk shaped lubricating fluid dispenser 800 according to a ninth illustrative embodiment will be described. The disk shaped lubricating fluid dispenser 800 is very similar to the disk shaped lubricating fluid dispenser 32 described hereinabove and illustrates in FIG. 1-4. Accordingly, for concision purposes, only the differences therebetween will be described.

The disk shaped lubricating fluid dispenser 800 includes different shape of diffusing walls. A first level includes a V-shaped diffusion wall 802 while a second level includes a V-shaped diffusion wall 804 and two angled walls 806. The third level includes six angled diffusion walls 808. A theoretical flow of fluid is illustrated by arrows 810.

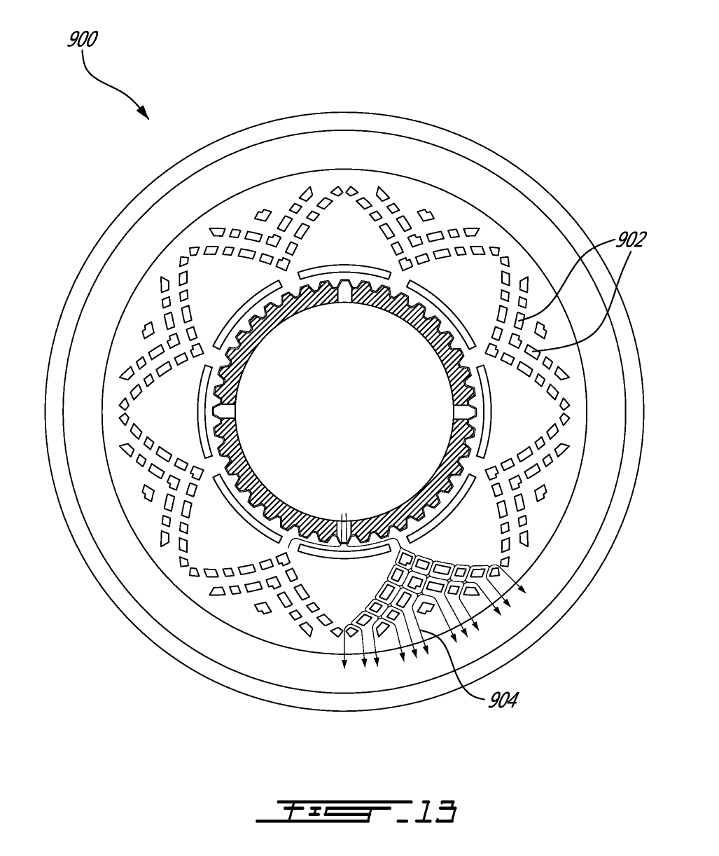

Turning now to FIG. 13 of the appended drawings, a disk shaped lubricating fluid dispenser 900 according to a tenth illustrative embodiment will be described. The disk shaped lubricating fluid dispenser 900 is very similar to the disk shaped lubricating fluid dispenser 32 described hereinabove and illustrates in FIG. 1-4. Accordingly, for concision purposes, only the differences therebetween will be described.

The diffusion walls 902 of the disk shaped lubricating fluid dispenser 900 have straight lines and sharp edges. The diffusion walls 902 are provided in a fan shape and many of their sharp edges are so provided as to divide the flow of fluid. The theoretical diffusing pattern of the walls 902 is shown by arrows 904.

One skilled in the art will understand that triangular space-limiting elements (not shown) similar to the elements 46 of FIG. 4 could be provided in the free spaces of the dispenser 900.

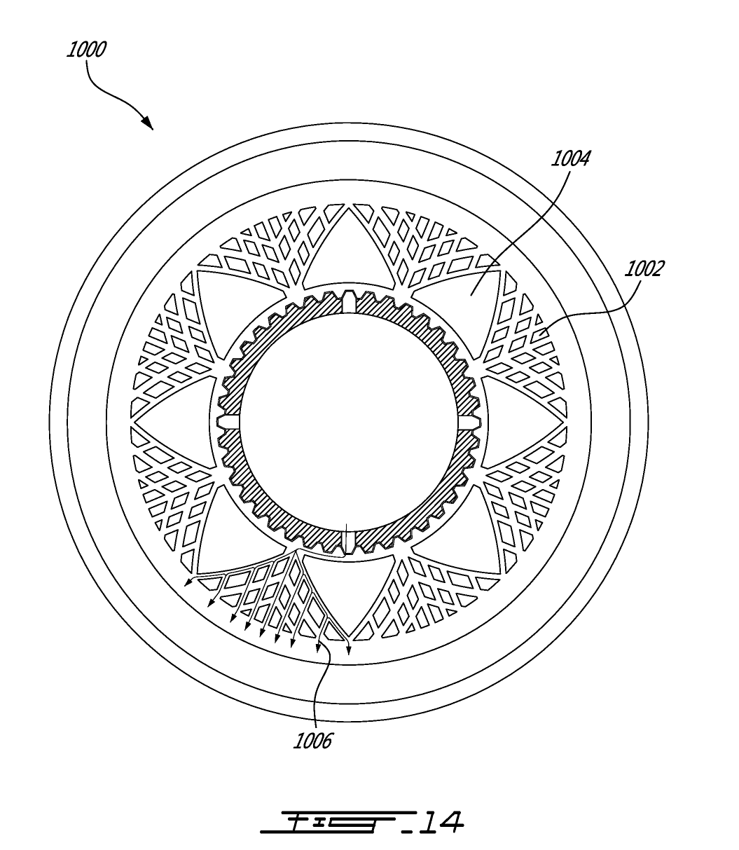

Turning now to FIG. 14 of the appended drawings, a disk shaped lubricating fluid dispenser 1000 according to a eleventh illustrative embodiment will be described. The disk shaped lubricating fluid dispenser 500 is very similar to the disk shaped lubricating fluid dispenser 32 described hereinabove and illustrates in FIG. 1-4. Accordingly, for concision purposes, only the differences therebetween will be described.

The disk shaped lubricating fluid dispenser 1000 includes a plurality of diffusing walls 1002 and eight generally triangular space-limiting elements 1004. The diffusing walls 1002 generally have straight lines and sharp edges. The diffusion walls 1002 are provided in a fan shape and many of their sharp edges are so provided as to divide the flow of fluid. The theoretical diffusing pattern is shown by arrows 1006.

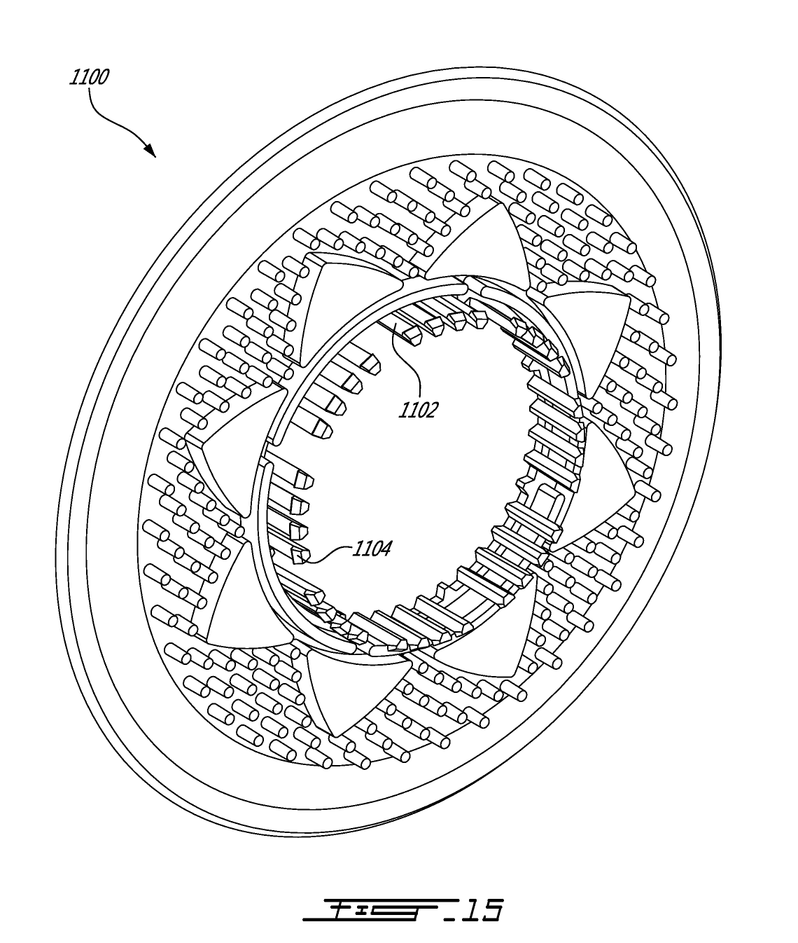

Turning finally to FIGS. 15 to 17 of the appended drawings, a disk shaped lubricating fluid dispenser 1100 according to a twelfth illustrative embodiment will be described. The disk shaped lubricating fluid dispenser 1100 is very similar to the disk shaped lubricating fluid dispenser 32 described hereinabove and illustrates in FIG. 1-4. Accordingly, for concision purposes, only the differences therebetween will be described.

The disk shaped lubricating fluid dispenser 1100 has the same diffusing pins and pattern as the dispenser 32 of FIGS. 1 to 4. The main difference between these dispensers is the means used to mount the dispensers to the disk 12. While the dispenser 32 used fasteners (not shown) inserted through apertures 45, the dispenser 45 includes a plurality of clips 1102 that are integral with the splines used to prevent rotation of the dispenser on the shaft 20.

As can be seen from FIG. 15, the clips 1102 each include an outwardly projecting tooth 1104. Also from FIG. 15, eight of the splines are free from clips 1102 to allow lubricating fluid therethrough as will be described hereinbelow.

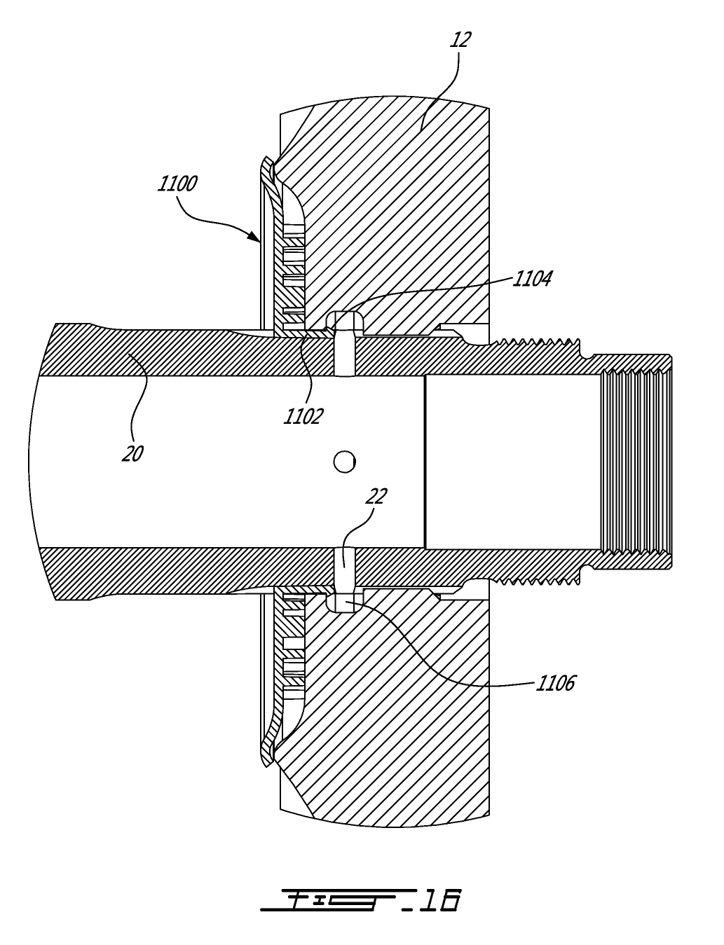

FIG. 16 is a sectional view illustrating the dispenser 1100 mounted to the disk 12. An oil chamber 1106 of the disk 12 is aligned with the lubricating fluid egress apertures 22 of the shaft 20 and is so positioned that the tooth 1104 of the clips 1102 can securely mount the dispenser 1100 to the disk 12.

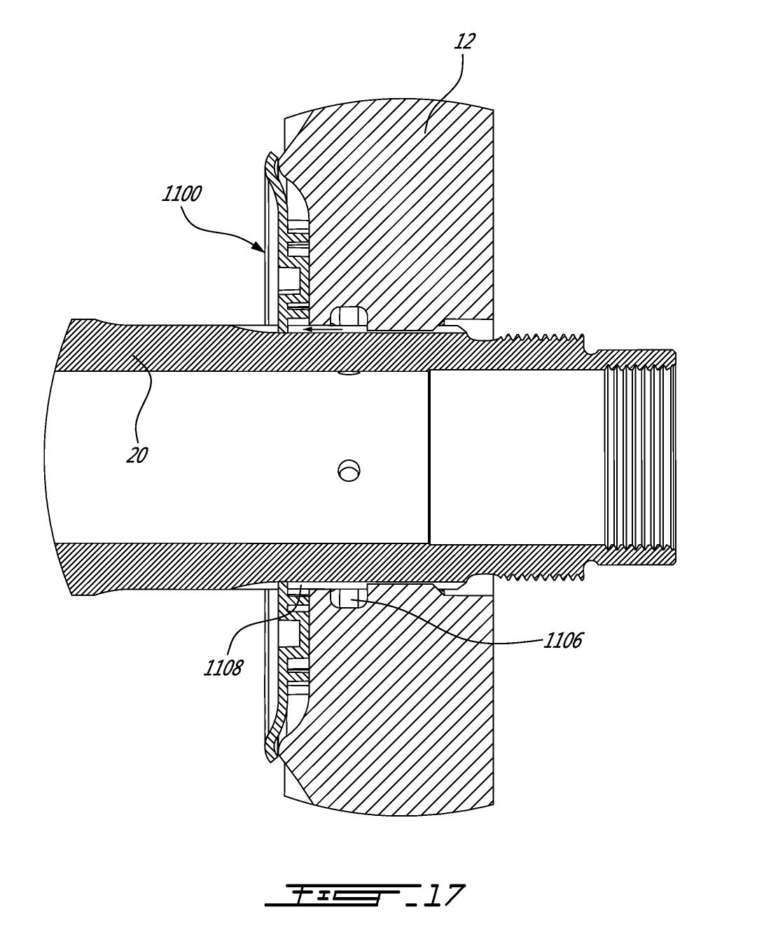

The eight missing clips illustrated in FIG. 15 allow the lubricating fluid to flow from the chamber 1106 to the dispenser 1100. Indeed, as illustrated in FIG. 17, the missing clips create a channel 1108 between the chamber 1106 and the dispenser 1100.

One skilled in the art will understand that either method of mounting the dispensers described hereinabove could be used for any of the dispensers described hereinabove.

The disk shaped lubricating fluid dispenser is made of a suitable material that is not adversely affected by the lubrication fluid used nor by the heat generated in the CVT. Suitable materials include, as non-limiting examples, plastics and metals.

One skilled in the art will understand that while the disk shaped lubricating fluid dispenser is described herein as being a one piece element, it could be made of separate elements interconnected together.

Furthermore, while a hollow shaft 20 provided with 4 lubricating fluid egress apertures 22 has been shown and described herein, one skilled in the art would be in a position to design an 8 apertures hollow shaft that would be aligned with the triangular space-limiting elements. Similarly, one could design a disk shaped lubricating fluid dispenser provided with 8 primary walls and 8 primary apertures aligned with the triangular space-limiting elements. On the other hand, less than four apertures or primary apertures could be used.

While the disk shaped lubricating fluid dispensers have been illustrated and described as mounted to the input disks 12 and 14, they could also be provide on both faces of the output disk 16.

While a CVT including two drive disks and one driven disk has been discussed hereinabove, a CVT having a central drive disk and two driven disks would also benefit from the above-described disk shaped lubricating fluid dispenser.

It is to be understood that the disk shaped lubricating fluid dispenser is not limited in its application to the details of construction and parts illustrated in the accompanying drawings and described hereinabove. The disk shaped lubricating fluid dispenser is capable of other embodiments and of being practiced in various ways. It is also to be understood that the phraseology or terminology used herein is for the purpose of description and not limitation. Hence, although the disk shaped lubricating fluid dispenser has been described hereinabove by way of illustrative embodiments thereof, it can be modified, without departing from the spirit, scope and nature thereof.

What is claimed is:

1. A disk shaped lubricating fluid dispenser including:
a generally circular body provided with a central opening; at least one fluid inlet apertures provided in the vicinity of the central opening;
for each at least one fluid inlet apertures, diffusing walls provided downstream from the at least two fluid inlet apertures;
whereby, fluid entering the disk shaped lubricating fluid dispenser through the at least one fluid inlet apertures is diffused by the diffusing walls.

2. A disk shaped lubricating fluid dispenser as recited in claim 1, wherein the diffusing walls include diffusing pins positioned as a curved Galton boards, so provided as to face each of the at least two fluid apertures.

3. A disk shaped lubricating fluid dispenser as recited in claim 2, wherein the diffusing pins have an oblong shape.

4. A disk shaped lubricating fluid dispenser as recited in claim 2, wherein the curve Galton board include six levels.

5. A disk shaped lubricating fluid dispenser as recited in claim 1, wherein the at least one fluid inlet aperture includes four fluid inlet apertures.

6. A disk shaped lubricating fluid dispenser as recited in claim 5, wherein for each fluid inlet aperture, the diffusing walls include a primary curved wall facing the fluid inlet aperture, the four primary curved walls being adjacent and defining four primary fluid apertures.

7. A disk shaped lubricating fluid dispenser as recited in claim 6, wherein the diffusing walls further include, for each primary fluid aperture, a secondary curved wall facing the primary aperture, the secondary curved wall including two opposite ends each defining a secondary fluid aperture.

8. A disk shaped lubricating fluid dispenser as recited in claim 7, wherein the diffusing walls further include, for each secondary fluid aperture, diffusing pins positioned as a curved Galton boards, so provided as to face the secondary fluid aperture.

9. A disk shaped lubricating fluid dispenser as recited in claim 7, wherein the diffusing walls further include, space saving elements provided between adjacent secondary fluid apertures.

10. A disk shaped lubricating fluid dispenser as recited in claim 1, wherein the diffusing walls include a plurality of levels of progressively smaller intermediate walls that are centered on the previous level of intermediate walls to thereby progressively divide the flow of lubricating fluid to diffuse the flow of lubricating fluid.

11. A disk shaped lubricating fluid dispenser as recited in claim 10, wherein the plurality of levels of progressively smaller intermediate walls include six levels of intermediate walls.

12. A disk shaped lubricating fluid dispenser as recited in claim 1, wherein the diffusing walls include, for each at least one fluid inlet aperture, fanning diffusing walls defining diffusing channels therebetween that split and diffuse the lubricating fluid.

13. A disk shaped lubricating fluid dispenser as recited in claim 12, wherein the fanning diffusing walls include five diffusing walls.

14. A disk shaped lubricating fluid dispenser as recited in claim 1, wherein the diffusing walls include, for each at least one fluid inlet aperture, a first level of diffusing walls including a square wall, a second level of diffusing wall including two arrow shaped walls and third and a fourth levels of diffusing walls including staggered diffusing pins.

15. A disk shaped lubricating fluid dispenser as recited in claim 1 wherein the diffusing walls include, for each at least one fluid inlet aperture, a first level of diffusing walls including a V-shaped diffusion wall, a second level of diffusing wall including a V-shaped diffusion wall and two angled walls and a third level of diffusing wall includes six angled diffusion walls.

16. A CVT provided with a hollow shaft supporting at least two disks having facing toroidal surfaces, at least one of the at least two disks being provided with a disk shaped lubricating fluid dispenser as recited in any of the preceding claims to diffuse lubricating fluid supplied by the hollow shaft.
